(19) United States
(12) Patent Application Publication
(10) Pub. No.: US 2025/0070205 A1
(43) Pub. Date: Feb. 27, 2025

(54) CONTROL DEVICE OF FUEL CELL SYSTEM

(71) Applicant: HONDA MOTOR CO., LTD., TOKYO (JP)

(72) Inventor: Kazuhiro YAMAMOTO, WAKO-SHI (JP)

(21) Appl. No.: 18/796,385

(22) Filed: Aug. 7, 2024

(30) Foreign Application Priority Data
Aug. 23, 2023 (CN) 202311071152.6

(51) Int. Cl. H01M 8/04746; H01M 8/04119; H01M 8/04858

(52) U.S. Cl. CPC H01M 8/04753; H01M 8/04119; H01M 8/0491

(57) ABSTRACT

A control device of a fuel cell system includes: a required value acquisition unit that acquires an oxygen-containing gas required value, which is an oxygen-containing gas flow rate to be supplied to a fuel cell stack; a pressure acquisition unit that acquires, from a pressure sensor, the pressure of oxygen-containing gas flowing through an oxygen-containing gas supply flow path; a pressure calculation unit that calculates a pressure change amount, which is an amount of change per predetermined time of the pressure acquired by the pressure acquisition unit; and a supply amount estimation unit. The supply amount estimation unit estimates the supply amount of the oxygen-containing gas supplied to the fuel cell stack, based on the pressure change amount, the volume of the oxygen-containing gas supply flow path, and the oxygen-containing gas required value.

### CROSS-REFERENCE TO RELATED APPLICATIONS

This application is based upon and claims the benefit of priority from Chinese Patent Application No. 202311071152.6 filed on Aug. 23, 2023, the contents of which are incorporated herein by reference.

### BACKGROUND OF THE INVENTION

### Field of the Invention

The present invention relates to a control device of a fuel cell system.

### Description of the Related Art

In recent years, research and development have been conducted on fuel cell systems that contribute to energy efficiency in order to ensure that more people have access to affordable, reliable, sustainable and modern energy.

A fuel cell system includes a fuel cell that generates electric power using a fuel gas and an oxygen-containing gas, an oxygen-containing gas supply flow path for supplying the oxygen-containing gas to the fuel cell, and an oxygen-containing gas supply unit (compressor) that supplies the oxygen-containing gas to the oxygen-containing gas supply flow path (for example, see JP 2004-355890 A).

### SUMMARY OF THE INVENTION

There has been a demand for a control device of a fuel cell system capable of accurately estimating a flow rate of an oxygen-containing gas supplied from an oxygen-containing gas supply flow path to a fuel cell.

An object of the present invention is to solve the aforementioned problem.

According to an aspect of the present invention, there is provided a control device of a fuel cell system that includes a fuel cell configured to generate electric power using a fuel gas and an oxygen-containing gas, an oxygen-containing gas supply flow path configured to supply the oxygen-containing gas to the fuel cell, and an oxygen-containing gas supply unit configured to supply the oxygen-containing gas to the oxygen-containing gas supply flow path, the control device comprising: a required value acquisition unit configured to acquire an oxygen-containing gas required value that is an oxygen-containing gas flow rate to be supplied to the fuel cell; a pressure acquisition unit configured to acquire, from a pressure sensor, a pressure of the oxygen-containing gas flowing through the oxygen-containing gas supply flow path; a pressure calculation unit configured to calculate a pressure change amount that is an amount of change per predetermined time of the pressure acquired by the pressure acquisition unit; and a supply amount estimation unit configured to estimate a supply amount of the oxygen-containing gas supplied to the fuel cell, based on a volume of the oxygen-containing gas supply flow path, the pressure change amount, and the oxygen-containing gas required value.

According to the present invention, the flow rate of the oxygen-containing gas supplied from the oxygen-containing gas supply flow path to the fuel cell can be accurately estimated.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view showing a configuration of a fuel cell system according to an embodiment of the present invention;

FIG. 2 is a flowchart showing a process of a control device of the fuel cell system; and

FIG. 3 is an explanatory view showing a relationship between a timing chart of an oxygen-containing gas supply unit, a supply path stop valve, and a discharge path stop valve, and an amount of an oxygen-containing gas supplied to a fuel cell stack.

### DETAILED DESCRIPTION OF THE INVENTION

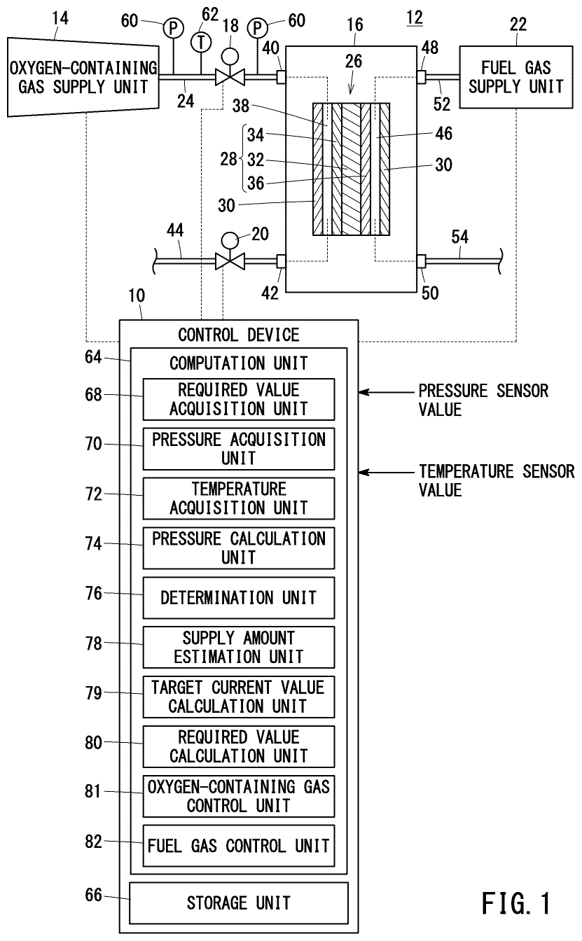

A control device 10 of a fuel cell system 12 according to an embodiment of the present invention will be described below with reference to the drawings. FIG. 1 is a schematic view showing a configuration of the fuel cell system 12 according to the present embodiment. As shown in FIG. 1, the fuel cell system 12 includes an oxygen-containing gas supply unit 14, a fuel cell stack (fuel cell) 16, a supply path stop valve 18, a discharge path stop valve 20, a fuel gas supply unit 22, and the control device 10.

The oxygen-containing gas supply unit 14 is a device that supplies an oxygen-containing gas to the fuel cell stack 16 through an oxygen-containing gas supply flow path 24. The oxygen-containing gas supply unit 14 is configured to be capable of adjusting the flow rate of the oxygen-containing gas supplied to the oxygen-containing gas supply flow path 24. The oxygen-containing gas supply unit 14 may be, for example, an air pump or a compressor, but is not limited thereto. The oxygen-containing gas may be air, but is not limited to air as long as it is a gas containing oxygen.

The fuel cell stack 16 generates electric power by an electrochemical reaction between a fuel gas and an oxygen-containing gas. The fuel gas is not particularly limited as long as it is a gas containing hydrogen. The fuel cell stack 16 includes a plurality of power generation cells 26. Each power generation cell 26 includes a membrane electrode assembly (MEA) 28, and a pair of separators 30 that sandwich the membrane electrode assembly 28. The membrane electrode assembly 28 includes, for example, an electrolyte membrane 32 which is a perfluorosulfonic acid thin film containing water, and a cathode 34 and an anode 36 which sandwich the electrolyte membrane 32.

An oxygen-containing gas flow field 38 is formed on a surface of one of the pair of separators 30 that faces the membrane electrode assembly 28. The oxygen-containing gas flow field 38 allows communication between an oxygen-containing gas inlet 40 and an oxygen-containing gas outlet 42 of the fuel cell stack 16. The oxygen-containing gas inlet 40 is connected to the oxygen-containing gas supply flow path 24, and the oxygen-containing gas outlet 42 is connected to an oxygen-containing gas discharge flow path 44.

A fuel gas flow field 46 is formed on a surface of the other of the pair of separators 30 that faces the membrane electrode assembly 28. The fuel gas flow field 46 allows communication between a fuel gas inlet 48 and a fuel gas outlet 50 of the fuel cell stack 16. The fuel gas inlet 48 is connected to a fuel gas supply flow path 52, and the fuel gas outlet 50 is connected to a fuel gas discharge flow path 54.

In each of the power generation cells 26, a part of the oxygen-containing gas supplied to the oxygen-containing gas flow field 38 chemically reacts with the fuel gas supplied to the fuel gas flow field 46. A mixed gas containing the oxygen-containing gas that has not chemically reacted and water (water vapor) generated by the chemical reaction is collected as an off-gas and discharged from the oxygen-containing gas outlet 42 to the oxygen-containing gas discharge flow path 44. The oxygen-containing gas discharged to the oxygen-containing gas discharge flow path 44 is discharged to the atmosphere from the oxygen-containing gas discharge flow path 44.

The supply path stop valve 18 is provided in the oxygen-containing gas supply flow path 24. The supply path stop valve 18 opens and closes the oxygen-containing gas supply flow path 24 under the control of the control device 10. The supply path stop valve 18 may be a valve that can be opened or closed, or may be a valve whose opening degree can be adjusted.

The discharge path stop valve 20 is provided in the oxygen-containing gas discharge flow path 44. The discharge path stop valve 20 opens and closes the oxygen-containing gas discharge flow path 44 under the control of the control device 10. The discharge path stop valve 20 may be a valve that can be opened or closed, or may be a valve whose opening degree can be adjusted. In the present embodiment, the discharge path stop valve 20 is a valve whose opening degree can be adjusted.

The fuel gas supply unit 22 is provided on the fuel gas supply flow path 52. The fuel gas supply unit 22 is a device that supplies the fuel gas to the fuel cell stack 16 through the fuel gas supply flow path 52. The fuel gas supply unit 22 is configured to be capable of adjusting the flow rate of the fuel gas supplied to the fuel gas supply flow path 52. The fuel gas supply unit 22 includes an injector.

The fuel cell system 12 may include various devices such as a bypass flow path that connects the oxygen-containing gas supply flow path 24 and the oxygen-containing gas discharge flow path 44 to each other, a bypass valve that opens and closes the bypass flow path, and a humidifier that humidifies the oxygen-containing gas.

In the fuel cell system 12, the oxygen-containing gas is supplied from the oxygen-containing gas supply unit 14 to the oxygen-containing gas inlet 40 of the fuel cell stack 16 through the oxygen-containing gas supply flow path 24. The oxygen-containing gas supplied to the oxygen-containing gas inlet 40 is supplied to the cathode 34 through the oxygen-containing gas flow field 38 of each power generation cell 26.

On the other hand, the fuel gas is supplied from the fuel gas supply unit 22 to the fuel gas inlet 48 of the fuel cell stack 16 through the fuel gas supply flow path 52. The fuel gas supplied to the fuel gas inlet 48 is supplied to the anode 36 through the fuel gas flow field 46 of each power generation cell 26. Each power generation cell 26 generates electric power using the oxygen-containing gas supplied to the cathode 34 and the fuel gas supplied to the anode 36.

The oxygen-containing gas that has flowed through the oxygen-containing gas flow field 38 is discharged from the oxygen-containing gas outlet 42 to the oxygen-containing gas discharge flow path 44. The fuel gas that has flowed through the fuel gas flow field 46 is discharged from the fuel gas outlet 50 to the fuel gas discharge flow path 54.

A pressure sensor 60 and a temperature sensor 62 are connected to the control device 10. The pressure sensor 60 is provided in the oxygen-containing gas supply flow path 24. The pressure sensor 60 detects the pressure of the oxygen-containing gas flowing through the oxygen-containing gas supply flow path 24. Specifically, the pressure sensors 60 are provided on both the upstream side and the downstream side of the supply path stop valve 18 in the oxygen-containing gas supply flow path 24. In this case, even if a failure or the like occurs in one of the two pressure sensors 60, the pressure of the oxygen-containing gas flowing through the oxygen-containing gas supply flow path 24 can be detected. It should be noted that the pressure sensor 60 may be provided only on one of the upstream side or the downstream side of the supply path stop valve 18 in the oxygen-containing gas supply flow path 24. The temperature sensor 62 is provided in the oxygen-containing gas supply flow path 24. The temperature sensor 62 detects the temperature of the oxygen-containing gas flowing through the oxygen-containing gas supply flow path 24. The temperature sensor 62 is provided on the upstream side of the supply path stop valve 18 in the oxygen-containing gas supply flow path 24. It should be noted that, in the oxygen-containing gas supply flow path 24, the temperature sensor 62 may be provided on the downstream side of the supply path stop valve 18, or the temperature sensors 62 may be provided on both the upstream side and the downstream side of the supply path stop valve 18.

The control device 10 includes a computation unit 64 and a storage unit 66. The computation unit 64 is constituted by, for example, a processor such as a central processing unit (CPU) or a graphics processing unit (GPU), that is, processing circuitry.

The computation unit 64 includes a required value acquisition unit 68, a pressure acquisition unit 70, a temperature acquisition unit 72, a pressure calculation unit 74, a determination unit 76, a supply amount estimation unit 78, a target current value calculation unit 79, a required value calculation unit 80, an oxygen-containing gas control unit 81, and a fuel gas control unit 82. The required value acquisition unit 68, the pressure acquisition unit 70, the temperature acquisition unit 72, the pressure calculation unit 74, the determination unit 76, the supply amount estimation unit 78, the target current value calculation unit 79, the required value calculation unit 80, the oxygen-containing gas control unit 81, and the fuel gas control unit 82 can be realized by the computation unit 64 executing programs stored in the storage unit 66.

At least part of the required value acquisition unit 68, the pressure acquisition unit 70, the temperature acquisition unit 72, the pressure calculation unit 74, the determination unit 76, the supply amount estimation unit 78, the target current value calculation unit 79, the required value calculation unit 80, the oxygen-containing gas control unit 81, and the fuel gas control unit 82 may be realized by an integrated circuit such as an application specific integrated circuit (ASIC) or a field-programmable gate array (FPGA). At least part of the required value acquisition unit 68, the pressure acquisition unit 70, the temperature acquisition unit 72, the pressure calculation unit 74, the determination unit 76, the supply amount estimation unit 78, the target current value calculation unit 79, the required value calculation unit 80, the oxygen-containing gas control unit 81, and the fuel gas control unit 82 may be constituted by an electronic circuit including a discrete device.

The storage unit 66 is constituted by a volatile memory (not shown) and a non-volatile memory (not shown). Examples of the volatile memory include, for example, a random access memory (RAM) or the like. The volatile memory is used as a working memory of the processor and temporarily stores data and the like required for processing or computation. Examples of the non-volatile memory include, for example, a read only memory (ROM), a flash memory, or the like. The non-volatile memory is used as a storage memory and stores programs, tables, maps, and the like. At least part of the storage unit 66 may be included in the processor, the integrated circuit, or the like described above.

The required value acquisition unit 68 acquires an oxygen-containing gas required value which is an oxygen-containing gas flow rate to be supplied to the fuel cell stack 16. The pressure acquisition unit 70 acquires the pressure of the oxygen-containing gas flowing through the oxygen-containing gas supply flow path 24 from the pressure sensors 60. The pressure sensors 60 each output a detection signal (an analog signal or a digital signal) having a magnitude corresponding to the pressure of the oxygen-containing gas to the control device 10. In this case, the pressure acquisition unit 70 calculates the pressure of the oxygen-containing gas based on the output signals from the pressure sensors 60. The pressure sensors 60 may each calculate the pressure from the detection value and output the calculated pressure to the control device 10. In this case, the pressure acquisition unit 70 acquires the pressure output from each pressure sensor 60 as the pressure of the oxygen-containing gas without modification. The pressure acquisition unit 70 acquires the pressure of the oxygen-containing gas at predetermined time intervals. The pressure acquired by the pressure acquisition unit 70 (acquired pressure) is stored in the storage unit 66.

The temperature acquisition unit 72 acquires the temperature of the oxygen-containing gas flowing through the oxygen-containing gas supply flow path 24 from the temperature sensor 62. The temperature sensor 62 outputs a detection signal (an analog signal or a digital signal) having a magnitude corresponding to the temperature of the oxygen-containing gas to the control device 10. In this case, the temperature acquisition unit 72 calculates the temperature of the oxygen-containing gas based on the output signal from the temperature sensor 62. The temperature sensor 62 may calculate the temperature from the detection value and output the calculated temperature to the control device 10. In this case, the temperature acquisition unit 72 acquires the temperature output from the temperature sensor 62 as the temperature of the oxygen-containing gas without modification.

The pressure calculation unit 74 calculates a pressure change amount (pressure difference), which is an amount of change per predetermined time of the acquired pressure. The pressure calculation unit 74 calculates the pressure change amount by subtracting the pressure acquired the time before last from the pressure acquired the last time, for example. The pressure calculation unit 74 may calculate the pressure change amount by subtracting the pressure acquired last time from the pressure acquired this time.

The determination unit 76 determines a change (increase, decrease, or remaining constant) in a target power generation amount of the fuel cell stack 16. The supply amount estimation unit 78 estimates an amount of the oxygen-containing gas supplied to the fuel cell stack 16, based on the volume of the oxygen-containing gas supply flow path 24, the oxygen-containing gas required value, and the pressure change amount. The target current value calculation unit 79 calculates a target current value of the fuel cell stack 16 based on the estimated value of the supply amount of the oxygen-containing gas calculated by the supply amount estimation unit 78. The required value calculation unit 80 calculates a fuel gas flow rate to be supplied to the fuel cell stack 16, based on the target current value calculated by the target current value calculation unit 79.

The oxygen-containing gas control unit 81 drives the oxygen-containing gas supply unit 14, the supply path stop valve 18, and the discharge path stop valve 20 based on the oxygen-containing gas required value. The fuel gas control unit 82 drives the fuel gas supply unit 22 based on the supply amount of the oxygen-containing gas estimated by the supply amount estimation unit 78.

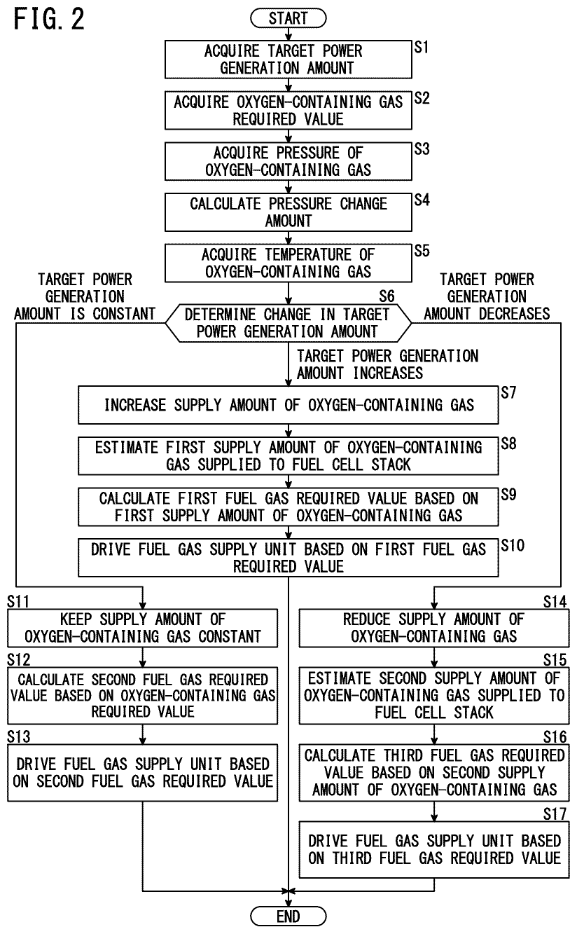

FIG. 2 is a flowchart showing a procedure of a process of the control device 10 of the fuel cell system 12. This process is executed at a predetermined cycle during power generation from the start to the stop of the power generation operation of the fuel cell stack 16.

As shown in FIG. 2, in step S1, the control device 10 acquires a target power generation amount of the fuel cell stack 16. The target power generation amount can be acquired from, for example, a higher-level control device (not shown). Thereafter, the process proceeds to step S2.

In step S2, the required value acquisition unit 68 acquires an oxygen-containing gas required value. The required value acquisition unit 68 can calculate the oxygen-containing gas required value based on the acquired target power generation amount. The oxygen-containing gas required value may be calculated by the higher-level control device. In this case, the required value acquisition unit 68 acquires the oxygen-containing gas required value from the higher-level control device. The acquired oxygen-containing gas required value is stored in the storage unit 66. Thereafter, the process proceeds to step S3.

In step S3, the pressure acquisition unit 70 acquires the pressure of the oxygen-containing gas flowing through the oxygen-containing gas flow field 38, from the pressure sensors 60. The acquired pressure is stored in the storage unit 66. Thereafter, the process proceeds to step S4.

In step S4, the pressure calculation unit 74 calculates a pressure change amount, which is an amount of change per predetermined time of the pressure acquired by the pressure acquisition unit 70. The calculated pressure change amount is stored in the storage unit 66. Thereafter, the process proceeds to step S5.

In step S5, the temperature acquisition unit 72 acquires the temperature of the oxygen-containing gas flowing through the oxygen-containing gas flow field 38 from the temperature sensor 62. The acquired temperature is stored in the storage unit 66. Thereafter, the process proceeds to step S6.

In step S6, the determination unit 76 determines a change in the target power generation amount. Specifically, the determination unit 76 determines that the target power generation amount is constant in a case where the target power generation amount falls within a steady power generation range. The determination unit 76 determines that the target power generation amount increases in a caser where the target power generation amount is larger than the previous target power generation amount. Further, the determination unit 76 determines that the target power generation amount decreases in a case where the target power generation amount is smaller than the previous target power generation amount. In a case where the determination unit 76 determines that the target power generation amount increases, the process proceeds to step S7.

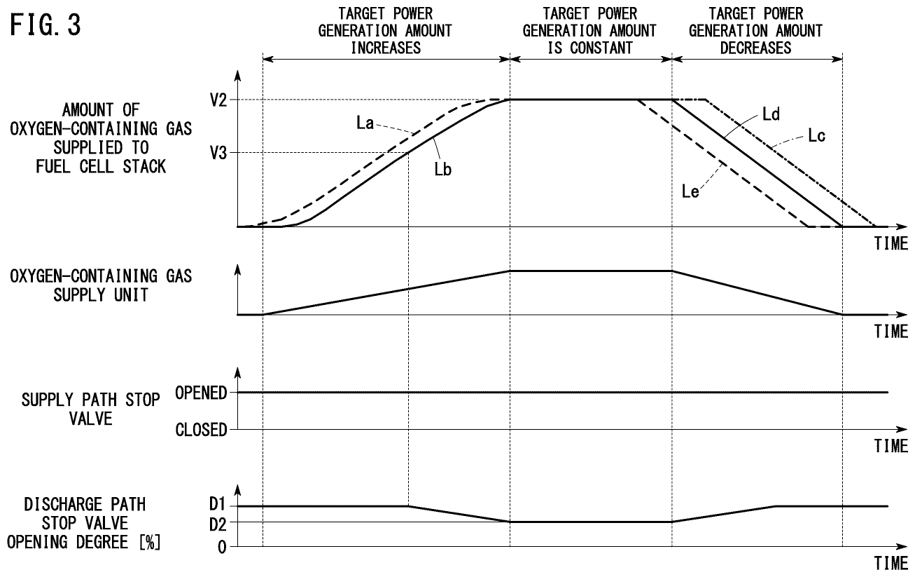

In step S7, the oxygen-containing gas control unit 81 drives the oxygen-containing gas supply unit 14, the supply path stop valve 18, and the discharge path stop valve 20 based on the oxygen-containing gas required value, and increases the amount of the oxygen-containing gas supplied to the fuel cell stack 16. Specifically, as shown in FIG. 3, the oxygen-containing gas control unit 81 increases the rotational speed of the oxygen-containing gas supply unit 14 and fully opens the supply path stop valve 18. Further, the oxygen-containing gas control unit 81 opens the discharge path stop valve 20 at a predetermined opening degree. The opening area of the supply path stop valve 18 is larger than the opening area of the discharge path stop valve 20.

When the rotational speed of the oxygen-containing gas supply unit 14 increases, the pressure of the oxygen-containing gas in the oxygen-containing gas supply flow path 24 increases. However, a part of the oxygen-containing gas supplied from the oxygen-containing gas supply unit 14 is not guided to the fuel cell stack 16, but is used to increase the pressure of the oxygen-containing gas in the oxygen-containing gas supply flow path 24. Therefore, the amount of the oxygen-containing gas supplied from the oxygen-containing gas supply flow path 24 to the fuel cell stack 16 is smaller than the amount of the oxygen-containing gas supplied from the oxygen-containing gas supply unit 14 to the oxygen-containing gas supply flow path 24. That is, the amount of the oxygen-containing gas actually supplied to the fuel cell stack 16 is smaller than the oxygen-containing gas required value.

In this case, for example, when the fuel gas in an amount corresponding to the oxygen-containing gas required value is supplied to the fuel cell stack 16, the supply amount of the oxygen-containing gas becomes less than the supply amount of the oxygen-containing gas required for the set stoichiometry in each of the power generation cells 26. In other words, in each of the power generation cells 26, the fuel gas is supplied in an amount larger than the amount of the fuel gas required for the set stoichiometry. In this case, the current limitation of the fuel cell stack 16 cannot be accurately performed.

In order to solve such a problem, in the present embodiment, in step S8, the supply amount estimation unit 78 estimates a first supply amount of the oxygen-containing gas supplied to the fuel cell stack 16. Specifically, the supply amount estimation unit 78 estimates a first supply amount V1 of the oxygen-containing gas using the following mathematical expression.

$$V 1 = Va - \frac{Δ PVb}{RT} \times m$$

In the above mathematical expression, Va represents the oxygen-containing gas required value, ΔP represents the pressure change amount, Vb represents the volume of the oxygen-containing gas supply flow path 24, R represents a gas constant, T represents the temperature of the oxygen-containing gas, and m represents the mass of the oxygen-containing gas per mole. The oxygen-containing gas required value acquired by the required value acquisition unit 68 is used as Va. The pressure change amount calculated by the pressure calculation unit 74 is used as ΔP. The temperature acquired by the temperature acquisition unit 72 is used as T. R and m are constants and are stored in the storage unit 66. Vb is a value determined by the length, size, shape, and the like of the oxygen-containing gas supply flow path 24 of the fuel cell system 12, and is stored in the storage unit 66.

In FIG. 3, a line segment La indicates a change in the oxygen-containing gas required value Va, and a line segment Lb indicates a change in the first supply amount V1 of the oxygen-containing gas calculated using the above mathematical expression. As shown in FIG. 3, the first supply amount V1 of the oxygen-containing gas estimated by the supply amount estimation unit 78 is smaller than the oxygen-containing gas required value Va.

It should be noted that, in the above-described step S7, the oxygen-containing gas control unit 81 continues to increase the rotational speed of the oxygen-containing gas supply unit 14 until the first supply amount V1 of the oxygen-containing gas reaches a set supply amount V2 in the periodic control in the flowchart of FIG. 2. Moreover, the oxygen-containing gas control unit 81 fully opens the supply path stop valve 18 from when the driving of the oxygen-containing gas supply unit 14 is started until when the first supply amount V1 of the oxygen-containing gas reaches the set supply amount V2. Further, the oxygen-containing gas control unit 81 opens the discharge path stop valve 20 at a first opening degree D1 until the first supply amount V1 of the oxygen-containing gas reaches a predetermined threshold V3. Furthermore, the oxygen-containing gas control unit 81 gradually decreases the opening degree of the discharge path stop valve 20 from when the first supply amount V1 of the oxygen-containing gas reaches the predetermined threshold V3 until when the first supply amount V1 reaches the set supply amount V2. At the time when the first supply amount V1 reaches the set supply amount V2, the opening degree of the discharge path stop valve 20 is a second opening degree D2. After step S8, the process proceeds to step S9.

As shown in FIG. 2, in step S9, the required value calculation unit 80 calculates a first fuel gas required value, which is a fuel gas flow rate to be supplied to the fuel cell stack 16, based on the first supply amount V1 of the oxygen-containing gas. Specifically, the target current value calculation unit 79 calculates a first target current value (limited current value) based on the first supply amount V1 of the oxygen-containing gas. The required value calculation unit 80 calculates the first fuel gas required value based on the first target current value calculated by the target current value calculation unit 79. Thereafter, the process proceeds to step S10.

In step S10, the fuel gas control unit 82 drives the fuel gas supply unit 22 based on the first fuel gas required value, and causes the fuel gas to be supplied to the fuel cell stack 16 in an amount corresponding to the first target current value calculated based on the first supply amount V1 of the oxygen-containing gas. In this case, the fuel gas control unit 82 controls the supply amount of the fuel gas so that the current value of the fuel cell stack 16 does not exceed the first target current value. As a result, the oxygen-containing gas and the fuel gas are supplied to each of the power generation cells 26 at the flow rate required for the set stoichiometry, and therefore, the current limitation of the fuel cell stack 16 can be accurately performed. Thereafter, the process shown in FIG. 2 is completed.

In step S6, in a case where the determination unit 76 determines that the target power generation amount is constant, the process proceeds to step S11.

In step S11, the oxygen-containing gas control unit 81 drives the oxygen-containing gas supply unit 14 based on the oxygen-containing gas required value Va to keep the amount of the oxygen-containing gas supplied to the fuel cell stack 16 constant. Specifically, as shown in FIG. 3, the oxygen-containing gas control unit 81 keeps the rotational speed of the oxygen-containing gas supply unit 14 constant. In this case, the supply path stop valve 18 is maintained in the fully open state, and the discharge path stop valve 20 is maintained at the second opening degree D2.

In such a steady power generation state, the pressure of the oxygen-containing gas in the oxygen-containing gas flow field 38 does not increase, and thus there is no large difference between the oxygen-containing gas required value Va and the amount of the oxygen-containing gas actually supplied to the fuel cell stack 16. After step S11, the process proceeds to step S12.

In step S12, the required value calculation unit 80 calculates a second fuel gas required value, which is a fuel gas flow rate to be supplied to the fuel cell stack 16, based on the oxygen-containing gas required value Va. Specifically, the target current value calculation unit 79 calculates a second target current value based on the oxygen-containing gas required value Va. Further, the required value calculation unit 80 calculates a second fuel gas required value based on the second target current value calculated by the target current value calculation unit 79. Thereafter, the process proceeds to step S13.

In step S13, the fuel gas control unit 82 drives the fuel gas supply unit 22 based on the second fuel gas required value, and causes the fuel gas in an amount corresponding to the oxygen-containing gas required value Va to be supplied to the fuel cell stack 16. Thereafter, the process shown in FIG. 2 is completed.

In step S6, in a case where the determination unit 76 determines that the target power generation amount decreases, the process proceeds to step S14.

In step S14, the oxygen-containing gas control unit 81 drives the oxygen-containing gas supply unit 14 and the discharge path stop valve 20 based on the oxygen-containing gas required value Va to reduce the amount of the oxygen-containing gas supplied to the fuel cell stack 16. Specifically, as shown in FIG. 3, the oxygen-containing gas control unit 81 reduces the rotational speed of the oxygen-containing gas supply unit 14 and increases the opening degree of the discharge path stop valve 20 from the second opening degree D2 to the first opening degree D1. Note that the supply path stop valve 18 is maintained in the fully open state.

When the rotational speed of the oxygen-containing gas supply unit 14 decreases, the flow rate of the oxygen-containing gas supplied from the oxygen-containing gas supply unit 14 to the oxygen-containing gas flow field 38 decreases, and the pressure of the oxygen-containing gas decreases. As a result, due to a decrease in the pressure in the oxygen-containing gas flow field 38, the amount of the oxygen-containing gas supplied to the fuel cell stack 16 increases. Further, since the oxygen-containing gas is supplied also from the oxygen-containing gas supply unit 14, the amount of the oxygen-containing gas supplied to the fuel cell stack 16 becomes larger than the oxygen-containing gas required value Va. In particular, in a case where the oxygen-containing gas supply unit 14 is an air pump, it is necessary to increase the pressure decrease rate of the air pump in order to avoid surging of the air pump, and therefore the amount of the oxygen-containing gas actually supplied to the fuel cell stack 16 becomes larger than the oxygen-containing gas required value Va.

In this case, for example, when the fuel gas in an amount corresponding to the oxygen-containing gas required value Va is supplied to the fuel cell stack 16, the supply amount of the oxygen-containing gas becomes larger than the supply amount of the oxygen-containing gas required for the set stoichiometry in each of the power generation cells 26. In this case, the current limitation cannot be accurately performed by simply calculating the target current value of the fuel cell stack 16 based on the oxygen-containing gas required value Va.

In order to solve such a problem, in the present embodiment, in step S15, the supply amount estimation unit 78 estimates a second supply amount of the oxygen-containing gas supplied to the fuel cell stack 16. Specifically, the supply amount estimation unit 78 estimates the second supply amount using the above-described mathematical expression. In this case, since the pressure in the oxygen-containing gas supply flow path 24 is taken into account in the above-described mathematical expression, the flow rate of the oxygen-containing gas supplied to the fuel cell stack 16 can be accurately estimated.

In FIG. 3, a line segment Lc indicates a change in the estimated value of an inflow amount of the oxygen-containing gas into the fuel cell stack 16 in a case where delay control is performed as a comparative example, and a line segment Ld indicates a change in the second supply amount calculated based on the above-described mathematical expression and the acquired pressure. A line segment Le indicates a change in the oxygen-containing gas required value Va.

When the delay control for delaying the oxygen-containing gas required value Va by a predetermined time is performed, the flow rate of the oxygen-containing gas supplied to the fuel cell stack 16 when the target power generation amount increases can be estimated to be smaller than the oxygen-containing gas required value Va. However, if the delay control is performed when the target power generation amount decreases, it is estimated that the oxygen-containing gas in an amount larger than the oxygen-containing gas required value Va (line segment Le) is supplied to the fuel cell stack 16. The supply amount estimated in the delay control is larger than the actual supply amount of the oxygen-containing gas.

In contrast, the second supply amount (line segment Ld) is a flow rate (appropriate flow rate) close to the actual supply amount of the oxygen-containing gas. Further, the supply amount estimated in the delay control is an amount obtained by uniformly delaying the oxygen-containing gas required value Va by a predetermined time, and therefore, in the delay control, a larger amount than the oxygen-containing gas required value Va is uniformly estimated. On the other hand, the supply amount estimation unit 78 can estimate the second supply amount so that the second supply amount variably changes with respect to the oxygen-containing gas required value Va. Therefore, even when the target power generation amount decreases, the second supply amount can be estimated as a value close to the actual supply amount of the oxygen-containing gas. After step S15, the process proceeds to step S16.

In step S16, the required value calculation unit 80 calculates a third fuel gas required value, which is a fuel gas flow rate to be supplied to the fuel cell stack 16, based on the second supply amount of the oxygen-containing gas. Specifically, the target current value calculation unit 79 calculates a third target current value (limited current value) based on the second supply amount of the oxygen-containing gas. Further, the required value calculation unit 80 calculates the third fuel gas required value based on the third target current value calculated by the target current value calculation unit 79. Thereafter, the process proceeds to step S17.

In step S17, the fuel gas control unit 82 drives the fuel gas supply unit 22 based on the third fuel gas required value, and causes the fuel gas to be supplied to the fuel cell stack 16 in an amount corresponding to the third target current value calculated based on the second supply amount of the oxygen-containing gas. In this case, the fuel gas control unit 82 controls the supply amount of the fuel gas so that the current value of the fuel cell stack 16 does not exceed the third target current value. As a result, the oxygen-containing gas and the fuel gas are supplied to each of the power generation cells 26 at the flow rate required for the set stoichiometry, and therefore, the current limitation of the fuel cell stack 16 can be accurately performed. Thereafter, the process shown in FIG. 2 is completed.

The process of the control device 10 is not limited to that in the above-described flowchart. The acquisition of the temperature of the oxygen-containing gas (step S5) may be performed before step S3 or may be performed simultaneously with step S3 or step S4. In a case where the fuel cell system 12 is provided in a vehicle, the determination unit 76 may determine the change in the target power generation amount based on the state of the vehicle in step S6. In this case, the determination unit 76 determines that the target power generation amount increases in a case where the acceleration of the vehicle is greater than an acceleration threshold. Further, the determination unit 76 determines that the target power generation amount decreases in a case where the deceleration of the vehicle is greater than a deceleration threshold. Furthermore, the determination unit 76 determines that the target power generation amount is constant in a case where the acceleration of the vehicle is equal to or less than the acceleration threshold, in a case where the deceleration of the vehicle is equal to or less than the deceleration threshold, or in a case where the acceleration of the vehicle is 0 (in a case where the vehicle is traveling at a constant speed or is stopped).

In step S6, in a case where the determination unit 76 determines that the target power generation amount is constant, the supply amount estimation unit 78 may estimate the amount of the oxygen-containing gas to be supplied to the fuel cell stack 16, based on the above-described mathematical expression, and the required value calculation unit 80 may calculate the second fuel gas required value based on this estimated value in step S12.

According to the present embodiment, the first supply amount V1 is estimated based on the pressure change amount, the volume of the oxygen-containing gas supply flow path 24, and the oxygen-containing gas required amount Va. Consequently, even when the pressure of the oxygen-containing gas in the oxygen-containing gas supply flow path 24 increases, the flow rate of the oxygen-containing gas supplied to the fuel cell stack 16 can be accurately estimated.

The following supplementary notes are further disclosed in relation to the above-described disclosure.

### Supplementary Note 1

The control device (10) of the fuel cell system (12) is a control device of a fuel cell system that includes the fuel cell (16) configured to generate electric power using the fuel gas and the oxygen-containing gas, the oxygen-containing gas supply flow path (24) configured to supply the oxygen-containing gas to the fuel cell, and the oxygen-containing gas supply unit (14) configured to supply the oxygen-containing gas to the oxygen-containing gas supply flow path, the control device including: the required value acquisition unit (68) configured to acquire the oxygen-containing gas required value (Va) that is the oxygen-containing gas flow rate to be supplied to the fuel cell; the pressure acquisition unit (70) configured to acquire, from the pressure sensor (60), the pressure of the oxygen-containing gas flowing through the oxygen-containing gas supply flow path; the pressure calculation unit (74) configured to calculate the pressure change amount that is an amount of change per predetermined time of the pressure acquired by the pressure acquisition unit; and the supply amount estimation unit (78) configured to estimate the supply amount of the oxygen-containing gas supplied to the fuel cell, based on the volume of the oxygen-containing gas supply flow path, the pressure change amount, and the oxygen-containing gas required value. According to such a configuration, the flow rate of the oxygen-containing gas supplied from the oxygen-containing gas supply flow path to the fuel cell can be accurately estimated. Further, the pressure change amount per predetermined time of the pressure acquired by the pressure acquisition unit may be an amount of change between the pressure acquired last time and the pressure acquired the time before last.

### Supplementary Note 2

The control device of the fuel cell system according to supplementary note 1 may further include the temperature acquisition unit (72) configured to acquire, from the temperature sensor (62), the temperature of the oxygen-containing gas flowing through the oxygen-containing gas supply flow path, and the supply amount estimation unit may estimate the supply amount of the oxygen-containing gas by further using the temperature acquired by the temperature acquisition unit. According to such a configuration, the amount of the oxygen-containing gas supplied to the fuel cell can be estimated with higher accuracy.

### Supplementary Note 3

In the control device of the fuel cell system according to supplementary note 1 or 2, the supply amount estimation unit may estimate the supply amount of the oxygen-containing gas in a case where the target power generation amount of the fuel cell is increased. In a case where the target power generation amount of the fuel cell is increased, the amount of the oxygen-containing gas supplied to the fuel cell becomes smaller than the oxygen-containing gas required value as the pressure of the oxygen-containing gas in the oxygen-containing gas supply flow path increases. However, according to the above configuration, even when the target power generation amount of the fuel cell is increased, the amount of the oxygen-containing gas supplied to the fuel cell can be accurately estimated.

### Supplementary Note 4

In the control device of the fuel cell system according to any one of supplementary notes 1 to 3, the supply amount estimation unit may estimate the supply amount of the oxygen-containing gas in a case where the target power generation amount of the fuel cell is decreased. In a case where the target power generation amount of the fuel cell is decreased, the oxygen-containing gas having a relatively high pressure existing in the oxygen-containing gas supply flow path is supplied to the fuel cell, and therefore, the amount of the oxygen-containing gas supplied to the fuel cell becomes larger than the oxygen-containing gas required value. However, according to the above configuration, even when the target power generation amount of the fuel cell is decreased, the amount of the oxygen-containing gas supplied to the fuel cell can be accurately estimated.

### Supplementary Note 5

The control device of the fuel cell system according to any one of supplementary notes 1 to 4 may further include the oxygen-containing gas control unit (81) configured to drive the oxygen-containing gas supply unit based on the oxygen-containing gas required value.

### Supplementary Note 6

The control device of the fuel cell system according to any one of supplementary notes 1 to 5 may further include the target current value calculation unit (79) configured to calculate the target current value of the fuel cell based on the estimated value of the supply amount of the oxygen-containing gas as calculated by the supply amount estimation unit.

### Supplementary Note 7

The control device of the fuel cell system according to any one of supplementary notes 1 to 5 may further include: the required value calculation unit (80) configured to, based on the supply amount estimated by the supply amount estimation unit, calculate the fuel gas required value that is the fuel gas flow rate to be supplied to the fuel cell; and the fuel gas control unit (82) configured to, based on the fuel gas required value, drive the fuel gas supply unit (22) configured to supply the fuel gas to the fuel cell. According to such a configuration, the current limitation of the fuel cell can be accurately performed.

### Supplementary Note 8

The control device of the fuel cell system according to supplementary note 6 may further include: the required value calculation unit configured to, based on the target current value calculated by the target current value calculation unit, calculate the fuel gas required value that is the fuel gas flow rate to be supplied to the fuel cell; and the fuel gas control unit configured to, based on the fuel gas required value, drive the fuel gas supply unit configured to supply the fuel gas to the fuel cell.

The present invention is not limited to the above disclosure, and various modifications are possible without departing from the essence and gist of the present invention.

1. A control device of a fuel cell system that includes a fuel cell configured to generate electric power using a fuel gas and an oxygen-containing gas, an oxygen-containing gas supply flow path configured to supply the oxygen-containing gas to the fuel cell, and an oxygen-containing gas supply unit configured to supply the oxygen-containing gas to the oxygen-containing gas supply flow path,
the control device comprising one or more processors that execute computer-executable instructions stored in a memory,
wherein the one or more processors execute the computer-executable instructions to cause the control device to:
acquire an oxygen-containing gas required value that is an oxygen-containing gas flow rate to be supplied to the fuel cell;
acquire a pressure of the oxygen-containing gas flowing through the oxygen-containing gas supply flow path, from a pressure sensor;
calculate a pressure change amount that is an amount of change per predetermined time of the pressure that has been acquired; and
estimate a supply amount of the oxygen-containing gas supplied to the fuel cell, based on a volume of the oxygen-containing gas supply flow path, the pressure change amount, and the oxygen-containing gas required value.

2. The control device of the fuel cell system according to claim 1, wherein
the one or more processors cause the control device to:
acquire a temperature of the oxygen-containing gas flowing through the oxygen-containing gas supply flow path, from a temperature sensor; and
estimate the supply amount of the oxygen-containing gas by further using the temperature that has been acquired.

3. The control device of the fuel cell system according to claim 1, wherein
the one or more processors cause the control device to estimate the supply amount of the oxygen-containing gas in a case where a target power generation amount of the fuel cell is increased.

4. The control device of the fuel cell system according to claim 1, wherein
the one or more processors cause the control device to estimate the supply amount of the oxygen-containing gas in a case where a target power generation amount of the fuel cell is decreased.

5. The control device of the fuel cell system according to claim 1, wherein
the one or more processors cause the control device to drive the oxygen-containing gas supply unit based on the oxygen-containing gas required value.

6. The control device of the fuel cell system according to claim 1, wherein
the one or more processors cause the control device to calculate a target current value of the fuel cell based on a calculated estimated value of the supply amount of the oxygen-containing gas.

7. The control device of the fuel cell system according to claim 1, wherein
the one or more processors cause the control device to:
based on the supply amount that has been estimated, calculate a fuel gas required value that is a fuel gas flow rate to be supplied to the fuel cell; and
based on the fuel gas required value, drive a fuel gas supply unit configured to supply the fuel gas to the fuel cell.

8. The control device of the fuel cell system according to claim 6, wherein
the one or more processors cause the control device to:
based on the target current value that has been calculated, calculate a fuel gas required value that is a fuel gas flow rate to be supplied to the fuel cell; and
based on the fuel gas required value, drive a fuel gas supply unit configured to supply the fuel gas to the fuel cell.
